(19) United States
(12) Patent Application Publication
(10) Pub. No.: US 2005/0166448 A1
(43) Pub. Date: Aug. 4, 2005

(54) Skirt of a Christmas tree with decorative light string

(76) Inventor: Yu-Peng Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/770,497

(22) Filed: Feb. 4, 2004

(51) Int. Cl. A01G 13/02; A47G 33/12

(52) U.S. Cl. 47/32; 47/32.4

(57) ABSTRACT

The invention relates to a skirt of a Christmas tree having decorative light string, which mainly provides an improvement of the tree skirt used on the Christmas tree. The improved tree skirt can be connected with a light string by any desired method to provide a lighting effect for increasing decorative purpose of the whole assembly.

### BACKGROUND OF THE INVENTION

A Christmas tree (1) is widely used for decoration in Christmas festival. It is known that many decorations are put on the tree and a skirt (2) is usually placed around the bottom of the tree (1), as shown in FIG. 1. The skirt (2) can cover the root of the tree and provides a cushion for placing gifts thereon. It is the only function of the conventional tree skirt (2), which seems monologue.

Accordingly, the present invention is to provide a tree skirt having decorative light string, which increases decorative effect of the whole body. Now, accompanying with the following drawings, the character of the present invention will be described here and after.

### BRIEF DESCRIPTION OF THE DRAWINGS

FIG. 1 is a perspective view showing a conventional tree skirt and a Christmas tree.

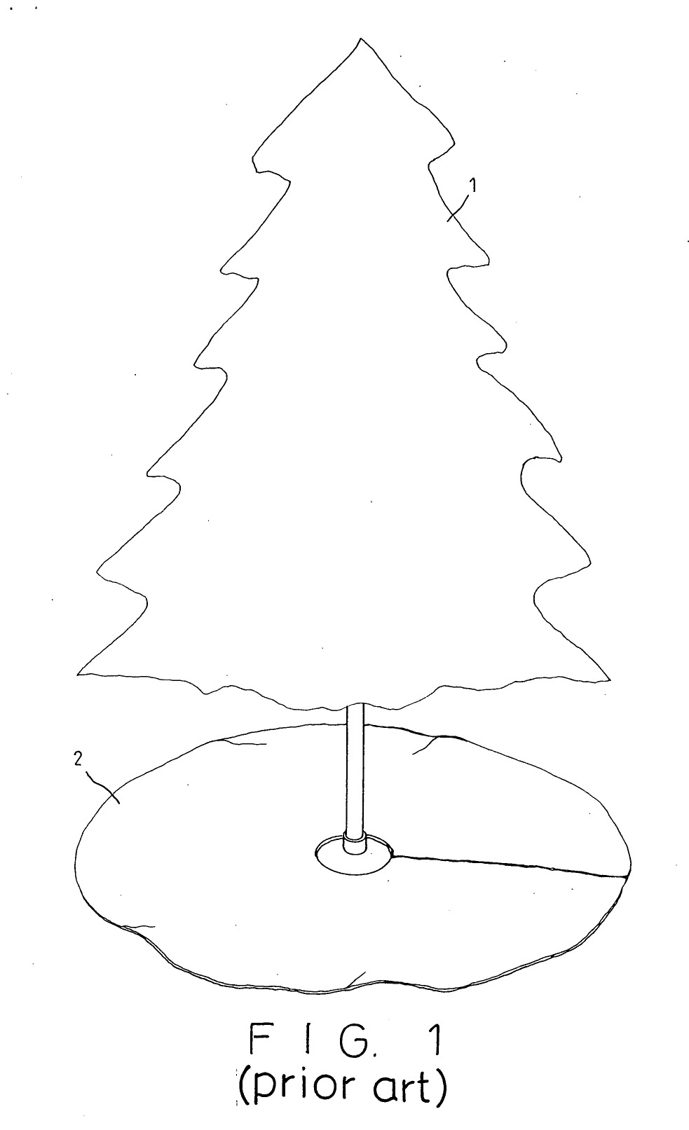

FIG. 2 is a perspective view showing a tree skirt with decorative light string according to the present invention.

FIG. 3 is a perspective view showing bottom layer of the tree skirt and the light string.

FIG. 4 is an enlarged perspective view showing parts of FIG. 3.

FIG. 5 is a perspective view showing FIG. 3 assembling with upper layer of the tree skirt.

FIG. 6 is a perspective view showing the assembly of bulbs and the upper layer of the tree skirt according to the present invention.

### DETAILED DESCRIPTION OF THE PREFERRED EMBODIMENT

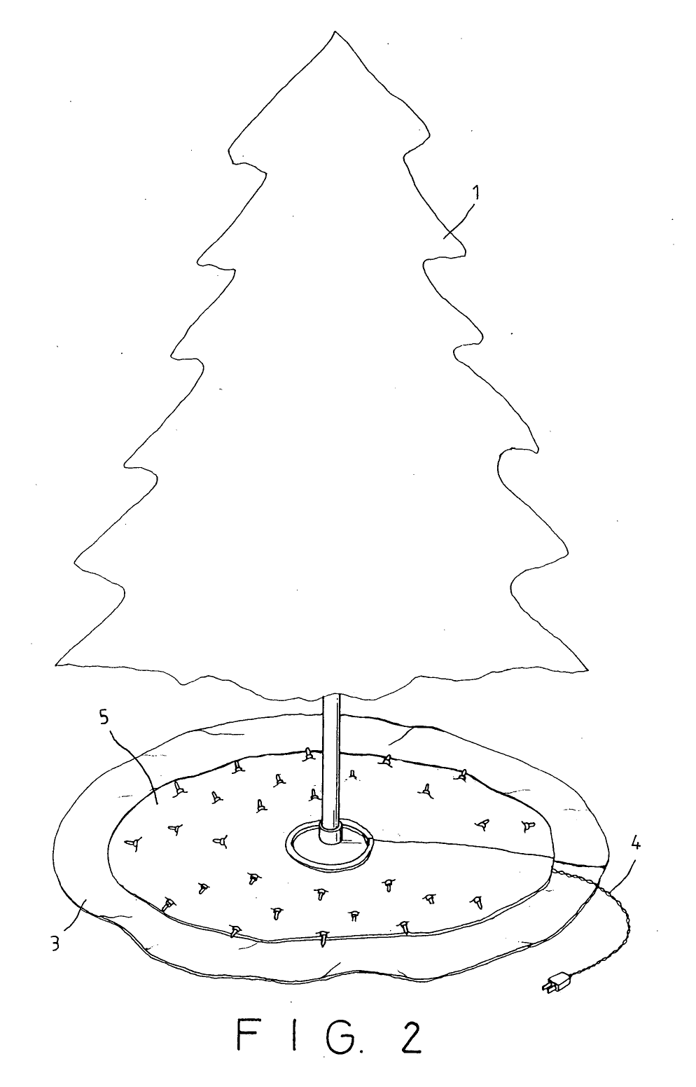

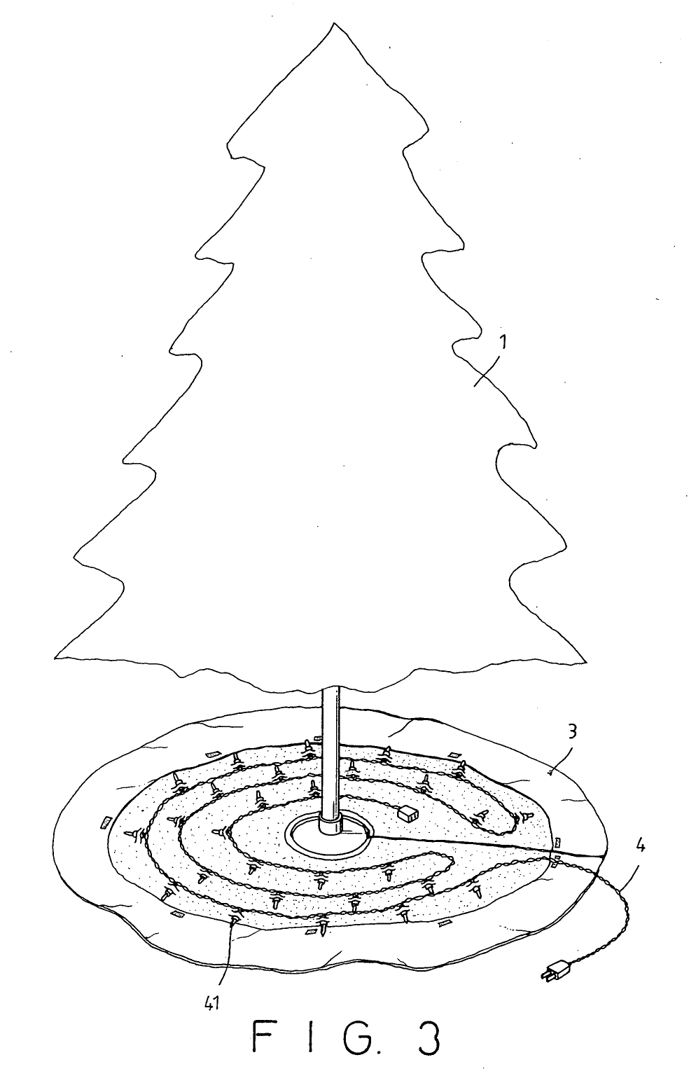

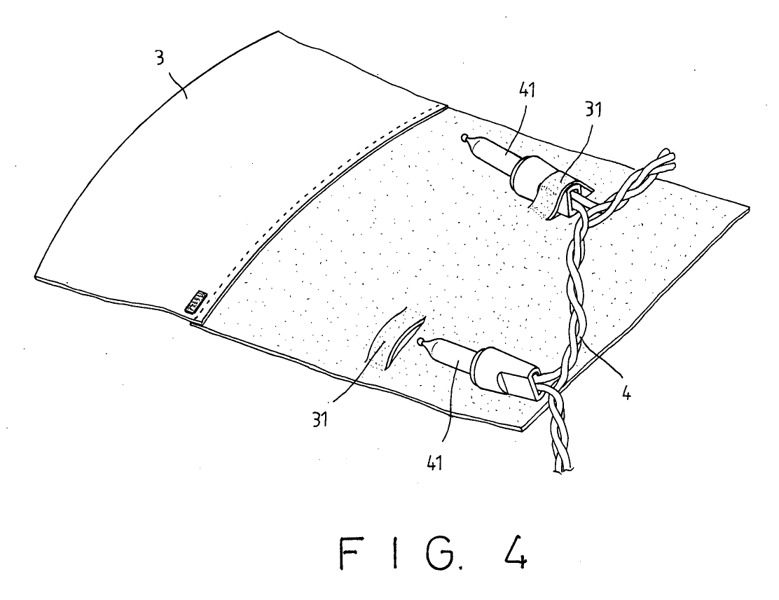

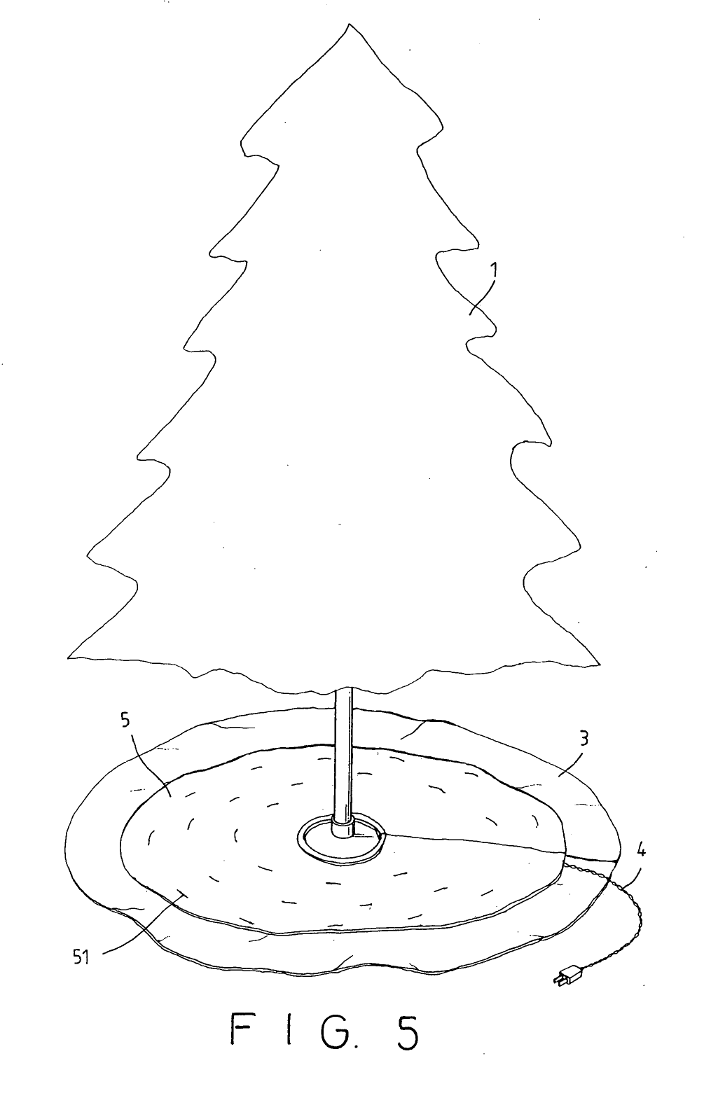

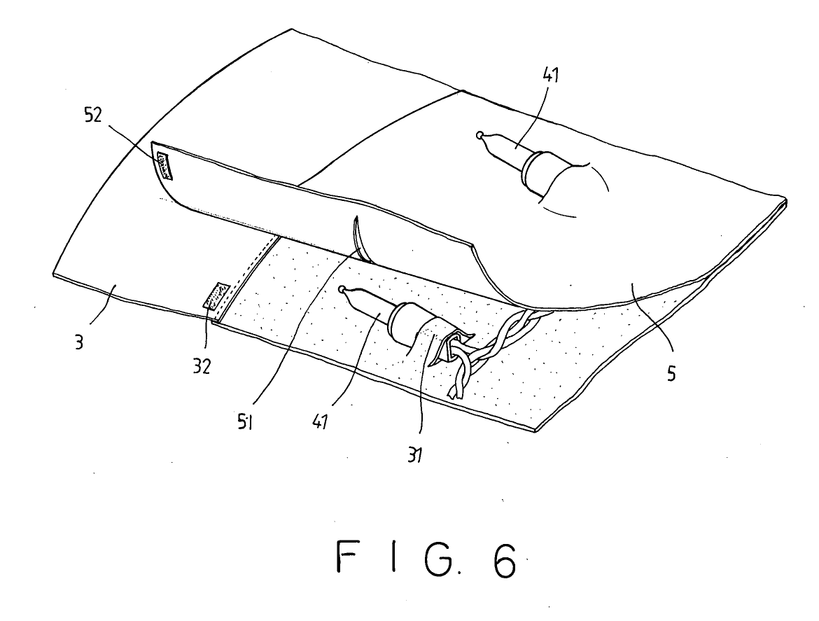

The present invention relates to a skirt of Christmas tree (1) having decorative light string, which includes a bottom layer (3), an S upper layer (5). of tree skirt and a light string (4) provided therebetween, as shown in FIG. 2. The light string (4) can be connected with the bottom tree skirt (3), such as by the way of FIGS. 3 and 4, wherein the bottom tree skirt (3) has provided with several belt (31) while each bulb assembly (41) of the light string (4) can be connected with a related belt (31) respectively. Then, the upper tree skirt (5) is cover thereon, as shown in FIGS. 5 and 6. The connection between two layers (3), (5) of the skirt can be completed by any desired method, such as using quick snapper (32) and (52).

Furthermore, the upper tree skirt (5) is provided with several opening (51) relating to the bulb assembly (41). The bulb assembly (41) can be then extruded from the opening (51) that forms the embodiment of the present invention as shown in FIG. 2.

Accordingly, in use, the present invention includes the basic prior function of the tree skirt and increases the whole decorative effect because of the lighting from the bulb assembly of the string. So the present invention is utilized and effective than ever. The above-mentioned embodiment is only an exemplary, which is not to limit the scope of the present invention. Any modified embodiment will be also claimed in this application, such as just connecting the bulb assembly on the tree skirt to provide a lighting effect.

1. A skirt of a Christmas tree having decorative light string including a bottom tree skirt and an upper tree skirt, and a light string being connected between two layers of the tree skirt to emit light for increasing decorative effect.

2. A skirt of a Christmas tree having decorative light string as claimed in claim 1, wherein the connection between two layers of the tree skirt can be completely by any desired method.

3. A skirt of a Christmas tree having decorative light string as claimed in claim 1, wherein the upper tree skirt has several opening relating to the bulb assembly of the light string, and each bulb assembly can be extruded from the relating opening of the upper tree skirt.

4. A skirt of a Christmas tree having decorative light string including a Christmas tree provided with a tree skirt around the bottom of the trunk wherein the tree skirt is connected with many bulb assemblies.
